(19) United States
(12) Patent Application Publication
(10) Pub. No.: US 2010/0307049 A1
(43) Pub. Date: Dec. 9, 2010

(54) Liquid Fuel for a Colored Flame

(76) Inventor: Ta-Chun PENG, Shanghai (CN)

Correspondence Address: Dr. BANGER SHIA;Patent Office of Bang Shia, 102 Lindencrest Ct., Sugar Land, TX, 77479-5201, US

(21) Appl. No.: 12/479,801

(22) Filed: Jun. 6, 2009

(51) Int. Cl. C11C 5/00

(52) U.S. Cl. 44/275

(57) ABSTRACT

A liquid fuel for a colored flame can be filled in containers of various shapes to make various artworks which can produce a colored flame when burning. The liquid fuel for a colored flame comprises a flame-coloring ingredient and a main combustible ingredient that are mixed during a heating process. The flame-coloring ingredient is made by mixing a chromogenic agent selected from a group consisting of metal chloride, metal bromide and boric acid with the water and the glycerin or with the water, the glycerin and the ethyl alcohol in a specific weight ratio. The main combustible ingredient is made by mixing the glycerin, the water and alcohol compounds in a specific weight ratio. Hence, the liquid fuel for a colored flame not only ensures a vivid and bright flame but increases the ignition point and combustion stability, thus solving the problems of low ignition point and high volatility.

### BACKGROUND OF THE INVENTION

1. Field of the Invention

The present invention relates to a liquid fuel for a colored flame; and more particularly to a liquid fuel for a colored flame which can produce different colored flames when burning and be produced into a torch, a needfire or a floating candle as desired.

2. Description of the Prior Art

In order to bring more festival atmosphere or satisfy the requirements of specific occasions, colored flame candles are often used to produce colored flames to create a joyous, romantic or mysterious atmosphere.

The existing colored flame candles are divided into two types: one is solid, and the other is liquid. The solid colored flame candles employ the conventional wax or lipid as the main combustible ingredient to cooperate with a candle wick made of flame-coloring ingredient to produce a colored flame when burning. It is known that such solid colored flame candles suffer from many drawbacks such as complicated structure, high cost, poor color effect, dripping, coking, etc. The liquid colored flame candles are made from colored flame liquid fuels that comprise a main combustible ingredient and a flame-coloring ingredient and can be filled in containers of various shapes, thus having the advantages of beautiful appearance, easy production, and low cost. However, the main combustible ingredient of the existing colored flame liquid fuel is based on ethyl alcohol, so this liquid fuel has a low ignition point and is highly volatile and consequently prone to spontaneous combustion when rubbing against or colliding with other objects, resulting in degradation of safety. Hence, it is needed to use special containers and anti-leakage designs during transporting, storing and using of such colored flame liquid fuel, which makes it difficult to be commercialized.

The present invention has arisen to mitigate and/or obviate the afore-described disadvantages.

### SUMMARY OF THE INVENTION

The primary objective of the present invention is to provide a liquid fuel for a colored flame which has the advantages of high ignition point, high safety, stable combustion, vivid flame color, low cost, and easy production.

In order to achieve the above objective, a liquid fuel for a colored flame in accordance with the present invention comprises a main combustible ingredient and a flame-coloring ingredient. The flame-coloring ingredient is made by mixing a chromogenic agent selected from a group consisting of metal chloride, metal bromide and boric acid with water and glycerin or with water, glycerin and ethyl alcohol in a specific weight ratio. The main combustible ingredient is made by mixing glycerin, water and alcohol compounds in a specific weight ratio.

Specifically, as for the flame-coloring ingredient, the weight ratio of chromogenic agent:water:glycerin is 100:200:1, or chromogenic agent:water:glycerin:ethyl alcohol is 100:200:1:500, and as for the main combustible ingredient, the weight ratio of water:glycerin:propylene glycol:ethylene glycol is 1:6:80:103, or water:glycerin:propylene glycol:ethyl alcohol:ethylene glycol is 1:6:80:10:103.

After the flame-coloring ingredient and the main combustible ingredient are made, a predetermined amount of flame-coloring ingredient and 1000 grams of main combustible ingredient will be put into a vessel synchronously and then heated to and kept at the temperature of 80 Celsius degrees while being stirred evenly to get a liquid fuel for a colored flame.

Further, the chromogenic agent of the flame-coloring ingredient can be lithium chloride, sodium chloride, cupric chloride, potassium bromide, boric acid which can be used to produce a red, a yellow, a blue, a purple or a green flame, respectively.

Hence, after the flame-coloring ingredient containing different chromogenic agents and the main combustible ingredient are mixed, a liquid fuel for a colored flame which can produce different colored flames when burning will be got. Since the main combustible ingredient of the present invention is made by mixing the glycerin, the water and the alcohol compounds, the main combustible ingredient of the present invention has a ignition point exceeding 380 Celsius degrees, thus not only producing a light blue flame caused by combustion of alcohol, but increasing the ignition point and the combustion stability. The flame-coloring ingredient and the main combustible ingredient are completely mixed during the heating process, which can eliminate the unevenness, the ignition point of the resultant liquid fuel for a colored flame of the present invention exceeds 410 Celsius degrees, thus not only ensuring vivid and bright flame, but increasing the safety.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

A flame-coloring ingredient using lithium chloride as a chromogenic agent is made by the steps of: preparing 4 grams of lithium chloride, water and glycerin in a weight ratio of 100:200:1; heating the water to 100 Celsius degrees; dissolving the lithium chloride by putting it into the heated water; adding the glycerin while stirring evenly to get the flame-coloring ingredient.

A flame-coloring ingredient using sodium chloride as a chromogenic agent is made by the steps of: preparing 1 gram of sodium chloride, water, and glycerin in a weight ratio of 100:200:1; heating the water to 100 Celsius degrees; dissolving the sodium chloride by putting it into the heated water; adding the glycerin while stirring evenly to get the flame-coloring ingredient.

A flame-coloring ingredient using cupric chloride as a chromogenic agent is made by the steps of: preparing 20 grams of cupric chloride, water, and glycerin in a weight ratio of 100:200:1; heating the water to 100 Celsius degrees; dissolving the cupric chloride by putting it into the heated water; adding the glycerin while stirring evenly to get the flame-coloring ingredient.

A flame-coloring ingredient using potassium bromide as a chromogenic agent is made by the steps of: preparing 5 grams of potassium bromide, water, and glycerin in a weight ratio of 100:200:1; heating the water to 100 Celsius degrees; dissolving the potassium bromide by putting it into the heated water; adding the glycerin while stirring evenly to get the flame-coloring ingredient.

A flame-coloring ingredient using boric acid as a chromogenic agent is made by the steps of: preparing 30 grams of boric acid, water, and glycerin in a weight ratio of 100:200:1; heating the water to 100 Celsius degrees; dissolving the boric acid by putting it into the heated water; adding the glycerin while stirring evenly to get the flame-coloring ingredient.

A main combustible ingredient is made by the steps of: preparing 1000 grams of water, glycerin, propylene glycol, and ethylene glycol in a weight ratio of 1:6:80:103, and then putting them into a vessel while stirring evenly to get the main combustible ingredient.

The 4 grams of flame-coloring ingredient using lithium chloride as the chromogenic agent and the 1000 grams of main combustible ingredient are put into a vessel synchronously, and then heated to and kept at the temperature of 80 Celsius degrees while being stirred evenly to allow them to dissolve into each other to get a red flame fuel.

The 1 gram of flame-coloring ingredient using sodium chloride as the chromogenic agent and the 1000 grams of main combustible ingredient are put into a vessel synchronously, and then heated to and kept at the temperature of 80 Celsius degrees while being stirred evenly to allow them to dissolve into each other to get a yellow flame fuel.

The 20 grams of flame-coloring ingredient using cupric chloride as the chromogenic agent and the 1000 grams of main combustible ingredient are put into a vessel synchronously, and then heated to and kept at the temperature of 80 Celsius degrees while being stirred evenly to allow them to dissolve into each other to get a blue flame fuel.

The 5 grams of flame-coloring ingredient using potassium bromide as the chromogenic agent and the 1000 grams of main combustible ingredient are put into a vessel synchronously, and then heated to and kept at the temperature of 80 Celsius degrees while being stirred evenly to allow them to dissolve into each other to get a purple flame fuel.

The 30 grams of flame-coloring ingredient using boric acid as the chromogenic agent and the 1000 grams of main combustible ingredient are put into a vessel synchronously, and then heated to and kept at the temperature of 80 Celsius degrees while being stirred evenly to allow them to dissolve into each other to get a green flame fuel.

The above coloring ingredients and the main combustible ingredient all don't any contain ethyl alcohol, but they can also be added with the ethyl alcohol to accelerate the dissolution, reference is made to the following embodiment.

A flame-coloring ingredient using lithium chloride as a chromogenic agent is made by the steps of: preparing 4 grams of lithium chloride, water, glycerin and ethyl alcohol in a weight ratio of 100:200:1:500; heating the water to 100 Celsius degrees; dissolving the lithium chloride by putting it into the heated water; adding the glycerin and the ethyl alcohol while stirring evenly to get the flame-coloring ingredient.

A flame-coloring ingredient using sodium chloride as a chromogenic agent is made by the steps of: preparing 1 gram of sodium chloride, water, glycerin and ethyl alcohol in a weight ratio of 100:200:1:500; heating the water to 100 Celsius degrees; dissolving the sodium chloride by putting it into the heated water; adding the glycerin and the ethyl alcohol while stirring evenly to get the flame-coloring ingredient.

A flame-coloring ingredient using cupric chloride as a chromogenic agent is made by the steps of: preparing 20 grams of cupric chloride, water, glycerin and ethyl alcohol in a weight ratio of 100:200:1:500; heating the water to 100 Celsius degrees; dissolving the cupric chloride by putting it into the heated water; adding the glycerin and ethyl alcohol while stirring evenly to get the flame-coloring ingredient.

A flame-coloring ingredient using potassium bromide as a chromogenic agent is made by the steps of: preparing 5 grams of potassium bromide, water, glycerin, and ethyl alcohol in a weight ratio of 100:200:1:500; heating the water to 100 Celsius degrees; dissolving the potassium bromide by putting it into the heated water; adding the glycerin and the ethyl alcohol while stirring evenly to get the flame-coloring ingredient.

A flame-coloring ingredient using boric acid as a chromogenic agent is made by the steps of: preparing 30 grams of boric acid, water, glycerin and ethyl alcohol in a weight ratio of 100:200:1:500; heating the water to 100 Celsius degrees; dissolving the boric acid by putting it into the heated water; adding the glycerin and the ethyl alcohol while stirring evenly to get the flame-coloring ingredient.

A main combustible ingredient is made by the steps of: preparing 1000 grams of water, glycerin, propylene glycol, ethyl alcohol, and ethylene glycol in a weight ratio of 1:6:80:10:103, and then putting them into a vessel while stirring evenly to get the main combustible ingredient.

The 4 grams of flame-coloring ingredient using lithium chloride as the chromogenic agent and the 1000 grams of main combustible ingredient are put into a vessel synchronously, and then heated to and kept at the temperature of 80 Celsius degrees while being stirred evenly to allow them to dissolve into each other to get a red flame fuel.

The 1 gram of flame-coloring ingredient using sodium chloride as the chromogenic agent and the 1000 grams of main combustible ingredient are put into a vessel synchronously, and then heated to and kept at the temperature of 80 Celsius degrees while being stirred evenly to allow them to dissolve into each other to get a yellow flame fuel.

The 20 grams of flame-coloring ingredient using cupric chloride as the chromogenic agent and the 1000 grams of main combustible ingredient are put into a vessel synchronously, and then heated to and kept at the temperature of 80 Celsius degrees while being stirred evenly to allow them to dissolve into each other to get a blue flame fuel.

The 5 grams of flame-coloring ingredient using potassium bromide as the chromogenic agent and the 1000 grams of main combustible ingredient are put into a vessel synchronously, and then heated to and kept at the temperature of 80 Celsius degrees while being stirred evenly to allow them to dissolve into each other to get a purple flame fuel.

The 30 grams of flame-coloring ingredient using boric acid as the chromogenic agent and the 1000 grams of main combustible ingredient are put into a vessel synchronously, and then heated to and kept at the temperature of 80 Celsius degrees while being stirred evenly to allow them to dissolve into each other to get a green flame fuel.

The above liquid fuels for producing different colored flames can be filled into the containers of various shapes as desired or produced into various artworks to have different combustion modes, such as produced into a torch, a needfire, or floating candle. In addition, you can produce candles by yourself using a cotton thread, a glass fiber or paper as wick which is placed into the liquid fuel and then ignited to produce a glaring colored flame.

While we have shown and described various embodiments in accordance with the present invention, it is clear to those skilled in the art that further embodiments may be made without departing from the scope of the present invention.

What is claimed is:

1. A liquid fuel for a colored flame comprising a flame-coloring ingredient and a main combustible ingredient that are mixed during a heating process, characterized in that:
the flame-coloring ingredient is made by mixing at least a chromogenic agent selected from a group consisting of metal chloride, metal bromide and boric acid with a water and a glycerin in a weight ratio of 100:200:1; and
the main combustible ingredient is made by mixing at least a water, a glycerin, a propylene glycol, and a ethylene glycol in a weight ratio of 1:6:80:103.

2. The liquid fuel for a colored flame as claimed in claim 1, characterized in that the flame-coloring ingredient further includes an ethyl alcohol in such a manner that the weight ratio of the chromogenic agent, the water, the glycerin and the ethyl alcohol of the flame-coloring ingredient is 100:200:1:500.

3. The liquid fuel for a colored flame as claimed in claim 1, characterized in that the main combustible ingredient further includes an ethyl alcohol in such a manner that the weight ratio of the water, the glycerin, the propylene glycol, the ethyl alcohol and the ethylene glycol of the main combustible ingredient is 1:6:80:10:103.

4. The liquid fuel for a colored flame as claimed in claim 1, characterized in that the metal chloride is selected form a group consisting of lithium chloride, sodium chloride, and cupric chloride, the metal bromide is potassium bromide.

5. The liquid fuel for a colored flame as claimed in claim 2, characterized in that the metal chloride is selected form a group consisting of lithium chloride, sodium chloride, and cupric chloride, the metal bromide is potassium bromide.

6. The liquid fuel for a colored flame as claimed in claim 1, characterized in that the flame-coloring ingredient using lithium chloride as the chromogenic agent and the main combustible ingredient are synchronously put into a vessel in a weight ratio of 4:1000 and heated to 80 Celsius degrees while being stirred evenly.

7. The liquid fuel for a colored flame as claimed in claim 2, characterized in that the flame-coloring ingredient using lithium chloride as the chromogenic agent and the main combustible ingredient are synchronously put into a vessel in a weight ratio of 4:1000 and heated to 80 Celsius degrees while being stirred evenly.

8. The liquid fuel for a colored flame as claimed in claim 3, characterized in that the flame-coloring ingredient using lithium chloride as the chromogenic agent and the main combustible ingredient are synchronously put into a vessel in a weight ratio of 4:1000 and heated to 80 Celsius degrees while being stirred evenly.

9. The liquid fuel for a colored flame as claimed in claim 1, characterized in that the flame-coloring ingredient using sodium chloride as the chromogenic agent and the main combustible ingredient are synchronously put into a vessel in a weight ratio of 1:1000 and heated to 80 Celsius degrees while being stirred evenly

10. The liquid fuel for a colored flame as claimed in claim 2, characterized in that the flame-coloring ingredient using sodium chloride as the chromogenic agent and the main combustible ingredient are synchronously put into a vessel in a weight ratio of 1:1000 and heated to 80 Celsius degrees while being stirred evenly.

11. The liquid fuel for a colored flame as claimed in claim 3, characterized in that the flame-coloring ingredient using sodium chloride as the chromogenic agent and the main combustible ingredient are synchronously put into a vessel in a weight ratio of 1:1000 and heated to 80 Celsius degrees while being stirred evenly.

12. The liquid fuel for a colored flame as claimed in claim 1, characterized in that the flame-coloring ingredient using cupric chloride as the chromogenic agent and the main combustible ingredient are synchronously put into a vessel in a weight ratio of 20:1000 and heated to 80 Celsius degrees while being stirred evenly.

13. The liquid fuel for a colored flame as claimed in claim 2, characterized in that the flame-coloring ingredient using cupric chloride as the chromogenic agent and the main combustible ingredient are synchronously put into a vessel in a weight ratio of 20:1000 and heated to 80 Celsius degrees while being stirred evenly.

14. The liquid fuel for a colored flame as claimed in claim 3, characterized in that the flame-coloring ingredient using cupric chloride as the chromogenic agent and the main combustible ingredient are synchronously put into a vessel in a weight ratio of 20:1000 and heated to 80 Celsius degrees while being stirred evenly.

15. The liquid fuel for a colored flame as claimed in claim 1, characterized in that the flame-coloring ingredient using potassium bromide as the chromogenic agent and the main combustible ingredient are synchronously put into a vessel in a weight ratio of 5:1000 and heated to 80 Celsius degrees while being stirred evenly.

16. The liquid fuel for a colored flame as claimed in claim 2, characterized in that the flame-coloring ingredient using potassium bromide as the chromogenic agent and the main combustible ingredient are synchronously put into a vessel in a weight ratio of 5:1000 and heated to 80 Celsius degrees while being stirred evenly.

17. The liquid fuel for a colored flame as claimed in claim 3, characterized in that the flame-coloring ingredient using potassium bromide as the chromogenic agent and the main combustible ingredient are synchronously put into a vessel in a weight ratio of 5:1000 and heated to 80 Celsius degrees while being stirred evenly.

18. The liquid fuel for a colored flame as claimed in claim 1, characterized in that the flame-coloring ingredient using boric acid as the chromogenic agent and the main combustible ingredient are synchronously put into a vessel in a weight ratio of 30:1000 and heated to 80 Celsius degrees while being stirred evenly.

19. The liquid fuel for a colored flame as claimed in claim 2, characterized in that the flame-coloring ingredient using boric acid as the chromogenic agent and the main combustible ingredient are synchronously put into a vessel in a weight ratio of 30:1000 and heated to 80 Celsius degrees while being stirred evenly.

20. The liquid fuel for a colored flame as claimed in claim 3, characterized in that the flame-coloring ingredient using boric acid as the chromogenic agent and the main combustible ingredient are synchronously put into a vessel in a weight ratio of 30:1000 and heated to 80 Celsius degrees while being stirred evenly.
